(19) United States
(12) Patent Application Publication
(10) Pub. No.: US 2019/0003840 A1
(43) Pub. Date: Jan. 3, 2019

(54) MAP REGISTRATION POINT COLLECTION WITH MOBILE DRONE

(71) Applicant: Faraday&Future Inc., Gardena, CA (US)

(72) Inventor: Xiufeng Song, San Jose, CA (US)

(21) Appl. No.: 15/690,162

(22) Filed: Aug. 29, 2017

Related U.S. Application Data
(60) Provisional application No. 62/381,452, filed on Aug. 30, 2016.

(51) Int. Cl. G01C 21/32; B64C 39/02; G01S 19/42; G06F 17/30; G06K 9/62; G06T 7/73

(52) U.S. Cl. CPC G01C 21/32; H04N 5/232; G01S 19/42; G06F 17/30241; G06F 17/30268; G06K 9/6202; G06T 7/74; B64C 2201/024; B64C 2201/123; B64C 2201/127; B64C 2201/208; B64C 2201/146; G06T 2207/10032; G06T 2207/30181; B64C 39/024

(57) ABSTRACT

Certain embodiments are described that provide a method for obtaining a registration point for a map. A drone is equipped with a GPS receiver and is flown to, and lands on, a physical location corresponding to a designated point on the map. While the drone is at the physical location, it receives GPS data using the GPS receiver for a period of time sufficient to allow convergence of the GPS data to obtain a GPS coordinate. The GPS coordinate is then associated with the designated point on the map, to generate the registration point for the map.

### CROSS-REFERENCE TO RELATED APPLICATIONS

This application claims the benefit of U.S. Provisional Application No. 62/381,452, filed Aug. 30, 2016, the entirety of which is hereby incorporated by reference.

### BACKGROUND

Aspects of the disclosure relate to obtaining registration points for map calibration purposes, such as for HAD (Highly Automated Driving) maps.

Most current maps for car navigation systems have precision down to a few meters. For self-driving cars, HAD maps with a precision of within 10-20 centimeters are desired.

Currently, maps can be generated using aerial photographs or other maps. A “registration point” on the aerial photograph is associated with a high-precision GPS location—with latitude, longitude, and altitude. Typically, a landmark on the aerial photograph is chosen, and a person is sent to the landmark with a GPS receiver to determine the location with high precision. The person holds the location equipment with the GPS receiver to collect GPS signals. This can require an extended period of time, such as 30 minutes to an hour. Because of ionic interference, building interference, and other causes, the GPS signals will vary over time, and vary depending on the satellites used. The data is collected and averaged over time until the average converges to a sufficiently precise value. That precise value is then used as the coordinates of the registration point.

The registration point coordinates are then assigned to a pixel on the aerial map corresponding to the landmark/registration point. While an aerial photo is described in this example, other types of images or maps could be used.

### SUMMARY

Certain embodiments are described that provide a method for obtaining a registration point for a map. A drone is equipped with a GPS receiver and is flown to, and lands on, a physical location corresponding to a designated point on the map. While the drone is at the physical location, it receives GPS data using the GPS receiver for a period of time sufficient to allow convergence of the GPS data to obtain GPS coordinates. The GPS coordinates are then associated with the designated point (pixel) on the map, to generate the registration point for the map.

In one embodiment, after the registration point coordinates are captured, the registration point can located on a map using image matching. A camera on the drone captures a drone image. An aerial image or other map is provided. Image matching is used to match the registration point on the drone image to a portion of the aerial image to locate the registration point on the aerial image. The GPS coordinates of the registration point are then associated with a particular pixel on the aerial image.

### BRIEF DESCRIPTION OF THE DRAWINGS

Aspects of the disclosure are illustrated by way of example. In the accompanying figures, like reference numbers indicate similar elements.

FIG. 1 shows an embodiment of a drone equipped with GPS receivers;

FIG. 2 is a diagram illustrating the matching of a drone image with an aerial photo according to an embodiment;

FIG. 3 shows an embodiment of a drone control and communication system;

FIG. 4 shows an embodiment of electronic systems mounted on a drone; and

FIG. 5 illustrates an example of a computing system in which one or more embodiments may be implemented.

### DETAILED DESCRIPTION

Examples are described herein in the context of generating registration points for maps. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

The term “drone” as used herein includes any robotic or partially robotic device that can access a registration point, whether by flying or other means of locomotion (e.g., a wall climbing robot).

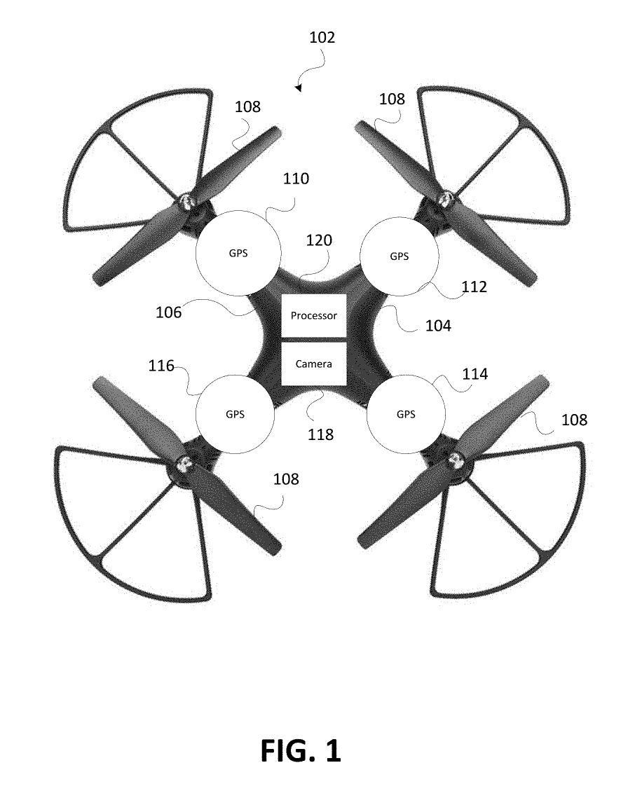

FIG. 1 shows an embodiment of a drone equipped with GPS receivers. A drone 102 is shown, with two intersecting bars 104 and 106 providing an X-shape. At each end of each bar is a propeller 108. The internal motors and controls are not shown. Added to drone 102 are four GPS receivers, 112, 114, 116 and 118. Alternately, a single GPS receiver, or a different number of GPS receivers could be used. A camera 118 is provided, and in one embodiment is pointing down from the bottom of the drone. A processor 120 processes the GPS data from the GPS receivers, and the image data from the camera, and saves the processed data in an onboard memory (shown in a subsequent figure). The camera can be a simple camera of the type used in smartphones. The camera and processor should have the resolution and computational capability sufficient for onboard and off-board information extraction.

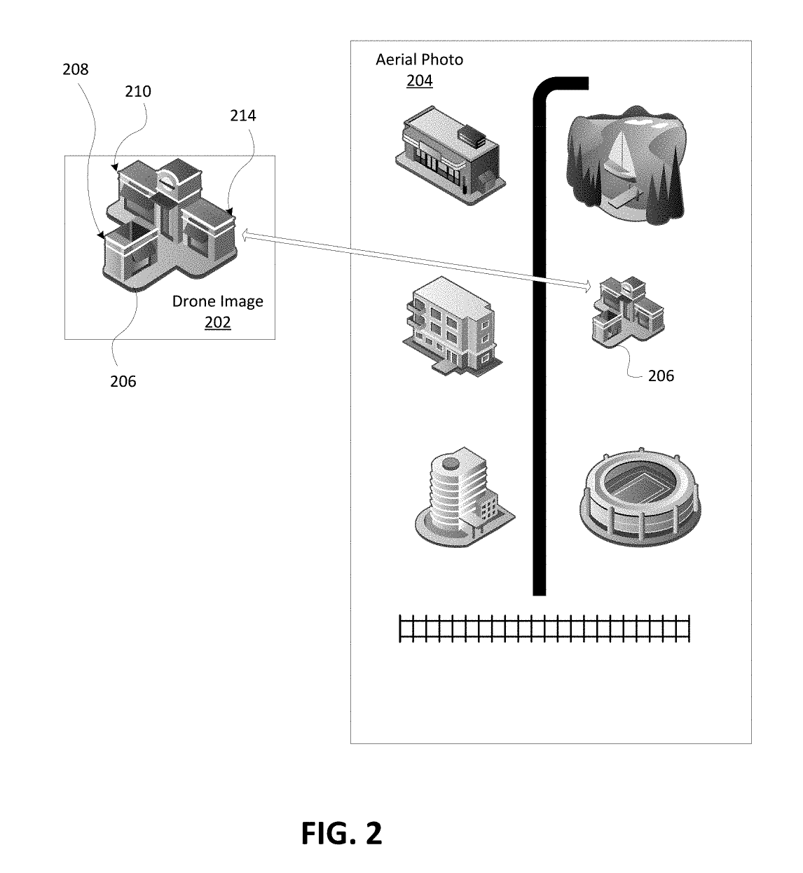

FIG. 2 is a diagram illustrating the matching of a drone image with an aerial photo according to an embodiment. A drone image 202 shows a shopping mall 206 that can be matched with a shopping mall 206 in aerial photo 204, either manually or with image matching software. Three different points on mall 206 are selected as registration points, points 208, 210 and 214. These points are chosen to have both different x and different y coordinates, and optionally different z coordinates. According to various embodiments, the reference points are chosen to be on roof tops or other elevated locations at positions with a good line of sight to multiple satellites and minimal interference of the GPS signals from the satellites. The coordinates of these points can then be assigned to the corresponding pixels on mall image 206 in aerial photo 204. The entire aerial photo 204 can then be adjusted appropriately to compensate for any distortion (e.g., tilt, yaw or roll) in the image. With additional registration points, it is then possible to interpolate to obtain the coordinates of intermediate pixels.

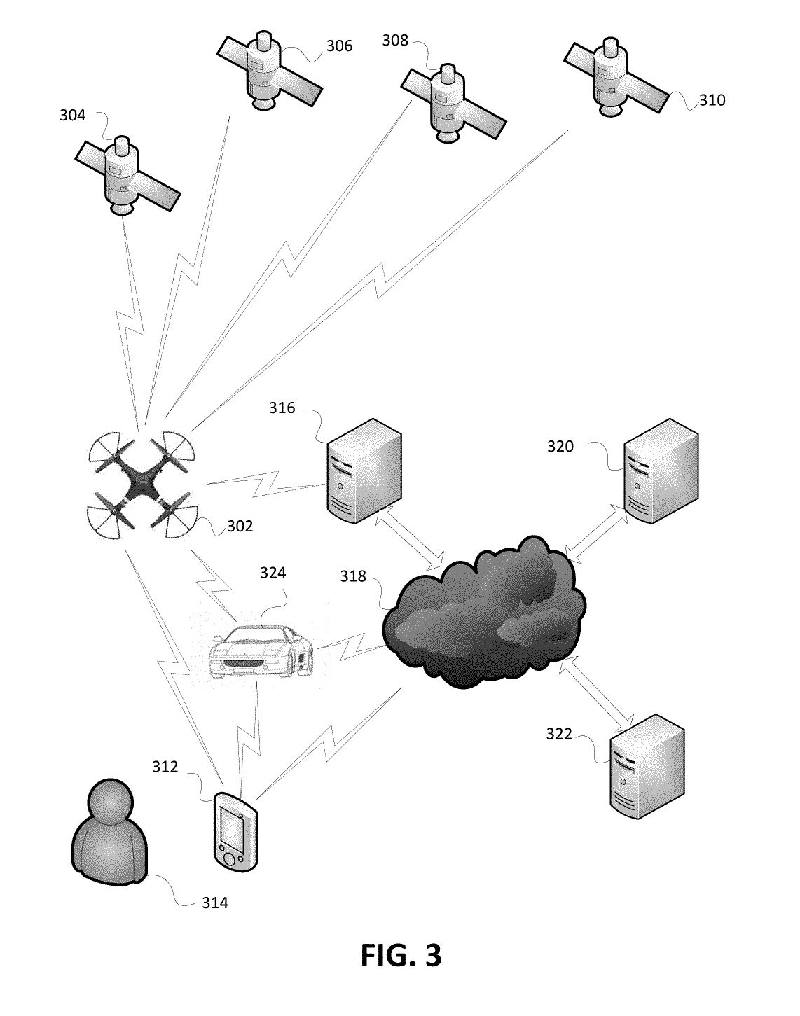

FIG. 3 shows an embodiment of a drone control and communication system. A drone 302 receives GPS signals from multiple satellites 304, 306, 308 and 310. The drone is controlled by a handheld remote control 312, such as a smart phone with a drone control application. The handheld remote control 312 is operated by a user 314. Alternately, handheld remote control could be replaced with a laptop computer, tablet, desktop computer, dedicated remote controller, or any other electronic device with remote control capability. In addition to control signals being sent from remote control 312 to drone 302, images from the drone's camera are transmitted to remote control 312 for display on a screen of the remote control or an associated display.

Image and other data from the drone 302 can also be transmitted to a remote server 316. Server 316 can, for example, aid in the selection of the registration point by comparing data on the possible registration point from the drone image to other information. For example, without a drone going to a location, it can be determined if the location has a line of sight to current satellite locations. The line of sight for a location can be calculated using a map and satellite location information in a database at server 316. Also, information from other servers can be retrieved over the Internet 318, such as weather information from a weather server 320 and other data from another server 322. Alternately, satellite position and other data can be stored in the memory on the drone, or in memory of one or more of the GPS receivers on the drone.

In one embodiment, a mobile relay vehicle 324 is used to relay signals from the drone to the remote control 312 and the remote server 316. Vehicle 324 can also be used to transport the drone to near the desired location. Also, remote control 312 can optionally be mounted or otherwise contained or carried by vehicle 312. Vehicle 312 can also be a relay drone, such as a larger drone.

### Process

Criteria to Select a Location for a Registration Point.

In some embodiments, the selection of a location for the registration point is mainly based on two criteria. First, the location should see a large area of the sky so that the drone can get enough GPS signals for the location production. Second, the location should provide a sharp, unobstructed view of the satellites (no trees, structures, clouds, etc. in the line of sight).

Selection of a Location for a Registration Point.

A potential location for a registration point is first selected. This can be done manually by an operator looking at a map, an image from a drone or an aerial photograph. The selection can also be done automatically by a program that processes map data to determine locations that have a good line of site to satellite locations and low interference based on the positions of adjacent structures on the map. In one embodiment, a camera on the drone captures an image. A drone operator or observer can view the drone image in real time and select an appropriate landing spot. By using a flying drone, locations that are not accessible or findable by a person on the ground can be selected as registration points. These locations can be chosen to have low interference. For example, locations higher than surrounding buildings, trees, and other sources of interference can be used to obtain a better GPS signal. The drone images can enable spotting and using such locations.

In one embodiment, a cursor or other indicator can be moved over various potential registration sites on the drone image sent back the operator. The image is also fed to a remote server, which calculates the desirability of the location as a registration point based on a variety of factors (alternately, the drone or remote controller processor can calculate the desirability, or do some of the calculations). One factor is a clear line of site to the desired satellites, and the minimization of reflected signals off nearby structures. The clear line of sight and lack of reflections can be determined by calculations using a map with the current positions or paths of the desired satellites. Such a map can be obtained from another remote server or a locally stored almanac. The system can also calculate the likelihood of reflected interference from nearby structures using a 3D map. Alternately or additionally, actual data from the drone can be used to determine such lines of sight and interference, as the drone approaches or is at the desired location. Also, if the initial GPS signals indicate a wide variation, and thus a likely long time to converge, the reliability can be updated and a location abort suggestion displayed to the operator.

The server program can also receive real-time weather data to determine the effects of cloud cover, local wind conditions, etc. Again, alternately or additionally, real-time sensor data from the drone can be used, such as images showing the sky or sonar or lidar readings indicating nearby structures. As the drone gets close or lands, information from local sensors (e.g., vibrations detected by an accelerometer due to wind) can be factored into the desirability. Since drones are lightweight, they may be blown around by the wind, especially at the top of tall buildings in a city. This will adversely impact the accuracy of the location data. It is desirable to keep the drone in exactly the same position.

The desirability of a location as a registration point can be displayed on the operator interface, and several potential sites can be compared by moving the cursor. This process can be automated, or semi-automated. In one embodiment, image comparison is done between a drone image and a preselected possible registration point on another map. Upon a match, the drone is automatically flown to that location. This can be done for multiple points, with initial measurements at each of the possible locations, then the selection of the best location for the longer-term GPS convergence routine.

In one embodiment, the drone is transported by another vehicle to near the desired registration location to minimize drone flying time, airspace control issues, etc. For example, an autonomous or semi-autonomous vehicle can be used. The vehicle can have a transceiver for communicating with the drone, and a relay module for relaying the communications over longer distances to a remote operator. The vehicle can transport a fleet of drones, and relay the communications for all the drones in the fleet, with each drone at a separate registration point. In an alternate embodiment, the drone can carry a GPS receiver(s) and processor module, and place it at a location, then return to pick-up and place other modules. This would allow calculations over an extended period of time, such as days, weeks or months, without tying up a drone. The drone could also place repeater/relay modules for communicating with a remote operator, or the modules could access local WiFi or other wireless networks.

Just prior to, during, and/or immediately after landing on a potential registration point location, the drone may take one or more pictures of the position and sends the picture(s) back to the central server. Since the drone can take a picture from above, this allows subsequent matching to an aerial photo or other map. In one embodiment, the location is chosen to have sharp lines, such as the corner of a building, so it is easier to precisely match to an aerial photograph.

Once the drone has landed at a potential registration point location, the drone may start the GPS location determining process and collect satellite signals. The drone will continue collecting data and calculating the location until the average location coordinates have converged to a desired accuracy of less than 20 centimeters, or more preferably less than 10 centimeters. Once there is convergence of the data, the drone processor computes the location coordinates of the registration point and sends them back to the remote server or operator, along with a previously taken picture(s) showing where the drone is precisely located.

In one embodiment, when finished, the drone will fly to the next registration point collection area, and repeat the process. Alternately, or in addition, a fleet of drones can operate at different locations at the same time.

### Criteria to Judge the Location Convergence

In one embodiment, the satellite data used to determine the location is divided into two data sets. Next, the average location for both sets is calculated. If the difference of these two locations are smaller than a threshold, for example, 5 cm, the drone processor will determine that the accuracy is good enough. Otherwise, the drone will keep collecting the location until convergence happens. The data can be alternately divided into 3 or more sets. The division into data sets can be a random or pseudo random division into two arbitrary sets.

### Methods for Faster Data Collection and Improved Convergence Rate

In one embodiment, a drone has a single GPS unit, and the GPS is in the center of body of the drone. Alternately, multiple GPS chips can be used, such as 4 or 5. The GPS chips can be located on the bar of the drone, or on the center of the drone. The relative location of each chip is known for the computations. The drone processor will use the calculated GPS coordinates from the multiple GPS receiver chips and combine them into a fused result for a particular time. The fusing would take into account the separate locations of the chips, which may be, for example, separated by 10-15 centimeters on the drone. This provides both a more accurate location than that from a single GPS, and faster convergence. The fused location is used to do the convergence analysis. One could average the locations from all GPS receivers to get the fusion location if the GPS receivers are installed symmetrically. Otherwise, proper weighting should be used to get the fused location if the installation is not perfectly symmetrical.

### Drone Electronics

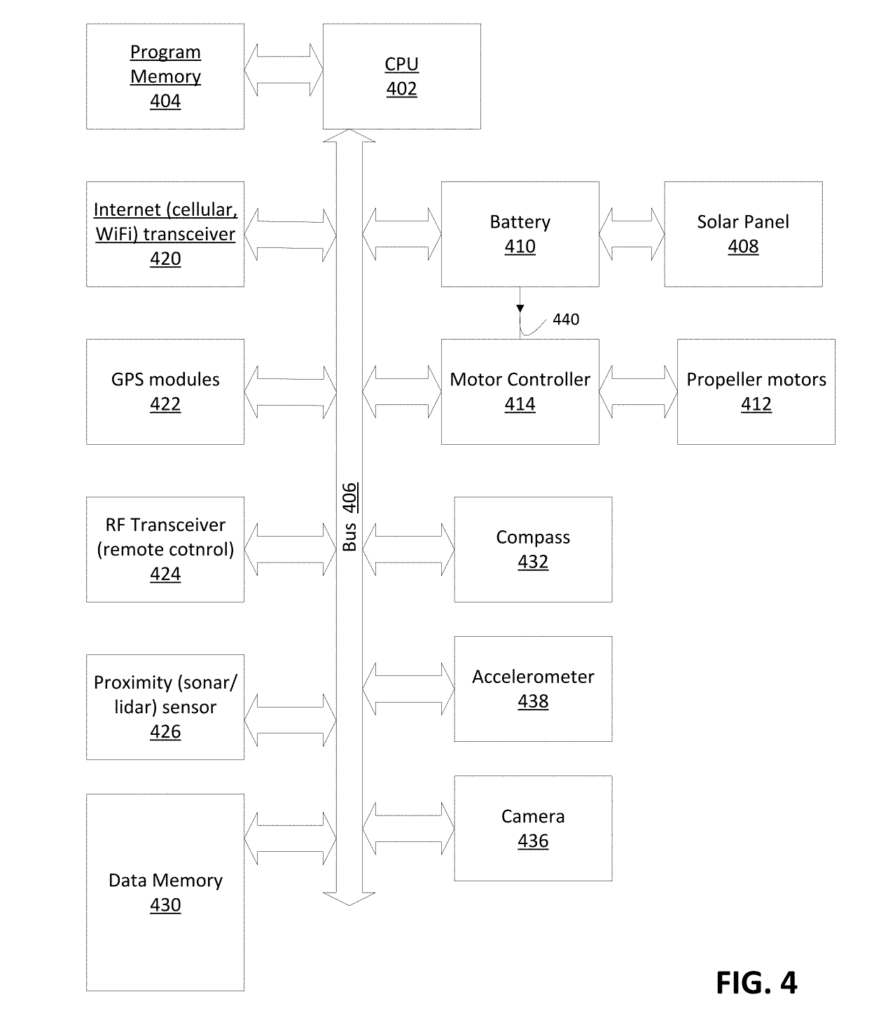

FIG. 4 shows an embodiment of electronic systems mounted on a drone. A CPU 402 operates under the control of a program memory 404 containing control software in a non-transitory computer readable medium. A bus 406 interconnects various modules of the system and can provide power to various components. The bus can be a Controller Area Network (CAN) or other bus. Alternately, separate connections are used. A solar panel 408 provides electrical charging to a battery 410. The battery can be the main drone battery, and/or a separate battery for processing and other electronics functions.

A communications transceiver 420 (e.g., Wi-Fi, cellular) can provide internet, text message, or other control capability for the system. For example, a user can use an application on a smart phone to provide instructions.

One or more GPS modules (chips) 422 receive satellite position data and perform convergence calculations to determine average coordinates. Alternately, the data or partial or complete calculations can be provided to the drone processor, CPU 402. A compass 432 provides the current orientation of the vehicle to be used in the calculations. The raw data and calculation results are stored in a data memory 430.

Motor controller 414 drives the drone propeller motors 412 to navigate the drone to the desired location. The location can be stored in memory with the drone operated on auto-pilot, or an operator can control the drone through an RF transceiver 424 (or transceiver 420). A proximity detector 426 can provide warnings, or automatically cause the drone to avoid obstacles. The proximity detector can use sonar, lidar, or other technologies. The proximity detector can also provide data on nearby obstacles and structures at a potential registration point, for use in evaluating the desirability of that point.

A movement sensor 438 (e.g., accelerometer) can be used to detect vibrations of the drone, which can be used to determine the effect of wind, structure swaying, tilting due to uneven landing surface, or other effects on the location of the drone.

A camera 436 provides images of the location before the drone lands, and/or after the drone takes off. The images can be used to register the location to an aerial or other map. The images can be stored in data memory 430, or transmitted to a remote operation or server. The images can be of lower resolution than the aerial images, since the drone will be closer to the ground location and thus the resolution for matching will be more than sufficient at a fairly low resolution. A standard smart phone camera would be more than adequate.

### Computer System

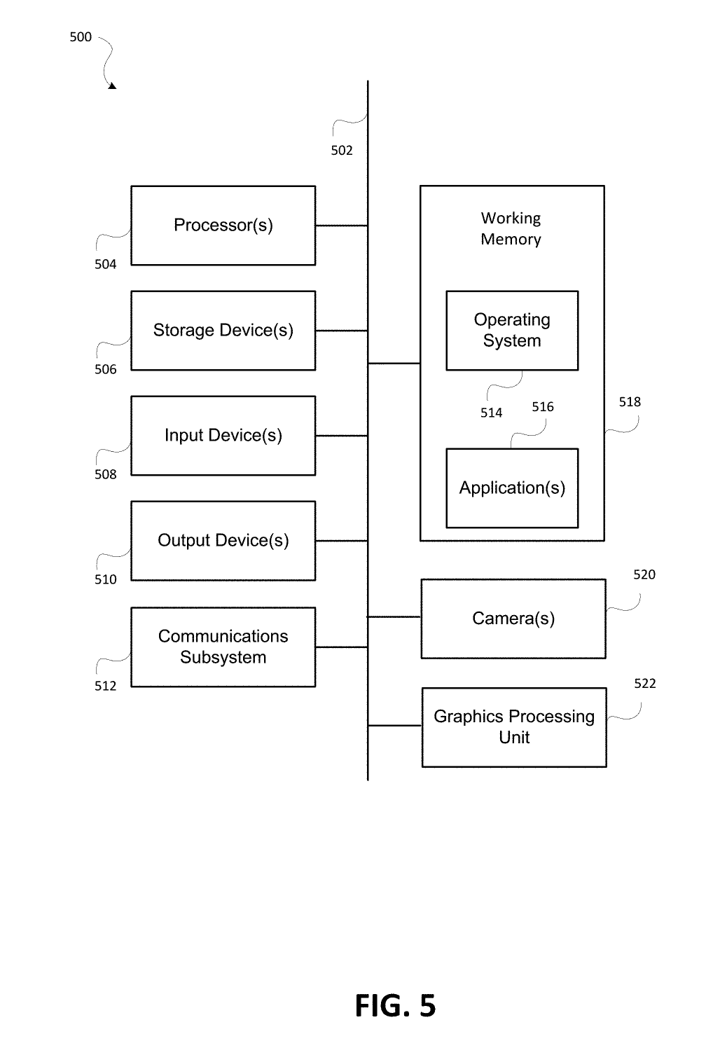

FIG. 5 illustrates an example of a computing system in which one or more implementations may be implemented.

A computer system as illustrated in FIG. 5 may be incorporated as part of the above described handheld remote control 312 and/or one of the servers 216, 312, and 320. For example, computer system 500 can represent some of the components of a display, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 5 provides a schematic illustration of one implementation of a computer system 500 that can perform the methods provided by various other implementations, as described herein, and/or can function as the host computer system, a remote kiosk/terminal, a telephonic or navigation or multimedia interface in an automobile, a computing device, a set-top box, a table computer and/or a computer system. FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 502 (or may otherwise be in communication, as appropriate). The hardware elements may include one or more processors 504, including without limitation one or more general-purpose processors and/or one or more special-purpose processors (such as digital signal processing chips, graphics processing units 522, and/or the like); one or more input devices 508, which can include without limitation one or more cameras, sensors, a mouse, a keyboard, a microphone configured to detect ultrasound or other sounds, and/or the like; and one or more output devices 510, which can include without limitation a display unit such as the device used in implementations of the invention, a printer and/or the like. Additional cameras 520 may be employed for detection of user's extremities and gestures. In some implementations, input devices 508 may include one or more sensors such as infrared, depth, and/or ultrasound sensors. The graphics processing unit 522 may be used to carry out the method for real-time wiping and replacement of objects described above.

In some implementations of the implementations of the invention, various input devices 508 and output devices 510 may be embedded into interfaces such as display devices, tables, floors, walls, and window screens. Furthermore, input devices 408 and output devices 510 coupled to the processors may form multi-dimensional tracking systems.

The computer system 500 may further include (and/or be in communication with) one or more non-transitory storage devices 506, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 500 might also include a communications subsystem 512, which can include without limitation a modem, a network card (wireless or wired), an infrared communication device, a wireless communication device and/or chipset (such as a Bluetooth device, an 802.11 device, a Wi-Fi device, a WiMax device, cellular communication facilities, etc.), and/or the like. The communications subsystem 512 may permit data to be exchanged with a network, other computer systems, and/or any other devices described herein. In many implementations, the computer system 500 will further comprise a non-transitory working memory 518, which can include a RAM or ROM device, as described above.

The computer system 500 also can comprise software elements, shown as being currently located within the working memory 518, including an operating system 514, device drivers, executable libraries, and/or other code, such as one or more application programs 516, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 506 described above. In some cases, the storage medium might be incorporated within a computer system, such as computer system 500. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 500 may be omitted or may be implemented separate from the illustrated system. For example, the processor 504 and/or other elements may be implemented separate from the input device 508. In one implementation, the processor may be configured to receive images from one or more cameras that are separately implemented. In some implementations, elements in addition to those illustrated in FIG. 5 may be included in the computer system 500.

Some implementations may employ a computer system (such as the computer system 500) to perform methods in accordance with the disclosure. For example, some or all of the procedures of the described methods may be performed by the computer system 500 in response to processor 504 executing one or more sequences of one or more instructions (which might be incorporated into the operating system 514 and/or other code, such as an application program 516) contained in the working memory 518. Such instructions may be read into the working memory 518 from another computer-readable medium, such as one or more of the storage device(s) 506. Merely by way of example, execution of the sequences of instructions contained in the working memory 518 might cause the processor(s) 504 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 500, various computer-readable media might be involved in providing instructions/code to processor(s) 504 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 506. Volatile media include, without limitation, dynamic memory, such as the working memory 518. Transmission media include, without limitation, coaxial cables, copper wire and fiber optics, including the wires that comprise the bus 502, as well as the various components of the communications subsystem 512 (and/or the media by which the communications sub system 512 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 504 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various implementations of the invention.

The communications subsystem 512 (and/or components thereof) generally will receive the signals, and the bus 502 then might carry the signals (and/or the data, instructions, etc. carried by the signals) to the working memory 518, from which the processor(s) 504 retrieves and executes the instructions. The instructions received by the working memory 518 may optionally be stored on a non-transitory storage device 406 either before or after execution by the processor(s) 504.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method for obtaining a registration point for a map, comprising:
providing a drone equipped with a GPS receiver;
landing the drone at a physical location corresponding to a designated point on the map;
while the drone is at the physical location, receiving GPS data using the GPS receiver for a period of time sufficient to allow convergence of the GPS data to a predetermined accuracy, to obtain a GPS coordinate; and
associating the GPS coordinate with the designated point on the map, to generate the registration point for the map.

2. The method of claim 1, further comprising:
providing a camera on the drone;
capturing an image using the camera; and
using the image captured by the camera as a factor in selecting the physical location.

3. The method of claim 2 wherein the step of using the image captured by the camera to select the physical location comprises:
comparing the captured image to a portion of a previously obtained aerial image associated with the map; and
in response to detecting a match between (a) the captured image and (b) the portion of the previously obtained aerial image, selecting a present location of the drone as the physical location and initiating the landing of the drone at the physical location.

4. The method of claim 1 further comprising:
providing a camera on the drone;
capturing a drone image using the camera;
obtaining a map;
using image matching to match to the drone image to a portion of the map to locate the registration point on the map; and
associating the GPS coordinate with the registration point on the map.

5. The method of claim 1 further comprising:
providing a plurality of GPS receivers on the drone;
receiving GPS data at each of the GPS receivers;
combining the GPS data from the plurality of GPS receivers into a fused result;
wherein the combining into a fused result adjusts for the different locations of the GPS receivers; and
continuing to generate fused results for a period of time sufficient to allow convergence of the GPS data to a predetermined accuracy of less than 20 centimeters.

6. The method of claim 1 further comprising:
calculating convergence of the GPS data by dividing the GPS data into at least two data sets, and separately calculating the convergence of each data set.

7. The method of claim 1 further comprising:
providing a vehicle for transporting the drone to a location near the physical location for initiating deployment of the drone.

8. The method of claim 7 further comprising:
a relay module mounted in the vehicle for relaying communications from the drone to one of a remote controller and a remote server.

9. The method of claim 1 further comprising determining a desirability of the physical location as a registration point by:
determining whether the physical location has a line of sight to at least four satellites using stored data on the position of the satellites and data regarding nearby structures;
determining the likelihood of reflected signals based on the data on nearby structures; and
determining an amount of interference based on data regarding current weather.

10. A system for obtaining a registration point for a map, comprising:
a drone equipped with a GPS receiver;
a drone motor controller for guiding the drone to a physical location corresponding to a designated point on the map;
at least one GPS receiver mounted on the drone for, while the drone is at the physical location, receiving GPS data using the GPS receiver for a period of time sufficient to allow convergence of the GPS data to a predetermined accuracy, to obtain a GPS coordinate; and
a processor, mounted on the drone, for calculating GPS coordinate for subsequent association of the GPS coordinate with the designated point on the map, to generate the registration point for the map.

11. The system of claim 10, further comprising:
a camera mounted on the drone;
non-transitory computer readable media stored in a memory mounted on the drone, for causing the processor to operate the camera to capture an image using the camera; and
the processor using the image captured by the camera as a factor in selecting the physical location.

12. The system of claim 10 further comprising:
a plurality of GPS receivers mounted on the drone;
non-transitory computer readable media stored in a memory mounted on the drone, for causing the processor to
receive GPS data at each of the GPS receivers;
combine the GPS data from the plurality of GPS receivers into a fused result;
adjust the fused results for the different locations of the GPS receivers; and
continue to generate fused results for a period of time sufficient to allow convergence of the GPS data to a predetermined accuracy of less than 20 centimeters.

13. The system of claim 10 further comprising:
a vehicle for transporting the drone to a location near the physical location for initiating deployment of the drone; and
a relay module mounted in the vehicle for relaying communications from the drone to one of a remote controller and a remote server.

14. The system of claim 10, further comprising:
a proximity sensor, mounted on the drone, for providing data to the processor to determine the effect of nearby structures on received GPS signals.

15. The system of claim 10, further comprising:
a drone transceiver mounted on the drone; and
a remote controller having a remote control transceiver for communicating commands and data with the drone transceiver.

16. The system of claim 10, further comprising:
a movement sensor mounted on the drone, for providing movement data to the processor to determine the desirability of the physical location.

17. An apparatus for obtaining a registration point for a map, comprising:
means for transporting to a physical location;
means, coupled to the means for transporting, for receiving GPS signals from a plurality of satellites;
means for calculating GPS coordinate data using the means for receiving, for a period of time sufficient to allow convergence of the GPS coordinate data to a predetermined accuracy, to obtain a GPS coordinate; and
means for associating the GPS coordinate with a designated point on the map, to generate the registration point for the map.

18. The apparatus of claim 17, further comprising:
means, mounted on the means for transporting, for capturing an image; and
means for using the image captured by the means for capturing as a factor in selecting the physical location.

19. The apparatus of claim 17 further comprising:
means, mounted on the means for transporting, for capturing a drone image;
means for obtaining a map;
means for using image matching to match to the drone image to a portion of the map to locate the registration point on the map; and
means for associating the GPS coordinate with the registration point on the map.

20. The apparatus of claim 17 further comprising:
means for calculating convergence of the GPS data by dividing the GPS data into at least two data sets, and separately calculating the convergence of each data set.
